(19) United States
(12) Patent Application Publication
(10) Pub. No.: US 2024/0430548 A1
(43) Pub. Date: Dec. 26, 2024

(54) OBSERVATION DEVICE

(71) Applicant: UAB Yukon Advanced Optics Worldwide, Vilnius (LT)

(72) Inventor: Aliaksandr Alsheuski, Vilnius (LT)

(21) Appl. No.: 18/699,401

(22) PCT Filed: Oct. 10, 2022
(86) PCT No.: PCT/EP2022/078146

§ 371 Date: Apr. 8, 2024

(30) Foreign Application Priority Data
Oct. 8, 2021 (GB) 2114413.4

(51) Int. Cl. H04N 23/13; F41G 1/38; G03B 29/00; H04N 23/11; H04N 23/53; H04N 23/63; H04N 23/667

(52) U.S. Cl. CPC H04N 23/13; F41G 1/38; G03B 29/00; H04N 23/11; H04N 23/531; H04N 23/632; H04N 23/667

(57) ABSTRACT

An observation device, which for example can be comprised in a scope or sighting device, which has first and second imaging modules (e.g. cameras, imagers, or the like) that obtain images of substantially the same scene or within overlapping fields of view but in different regions of the electromagnetic spectrum (e.g. infrared, thermal, visible, etc.) in a self-contained device or a modular device (where the modules are attached in use). The observation device generates a composite image in which a portion of an image obtained by one imaging module (i.e. in one region of the electromagnetic spectrum) is superimposed on another image (of substantially the same scene or within an overlapping field of view) obtained by the other imaging module (i.e. in a different region of the electromagnetic spectrum). The portion of the image which is superimposed on the other image occupies only a portion (i.e. not the whole, and preferably much less than 50%) of the composite image.

The present invention relates to observation devices such as night vision devices, thermal devices, range finders, sighting devices, scopes, and the like, as used by explorers, hunters, fishermen and nature enthusiasts for various activities. In particular, the present invention relates to various improvements to observation devices which result in increased functionality and improved utility, by enabling a user to be presented with more useful information during use.

### BACKGROUND TO THE INVENTION

Observation devices such as night vision devices, thermal devices, range finders, sighting devices, scopes, and the like, as used by explorers, hunters, fishermen and nature enthusiasts for various activities, typically operate in a single region of the electromagnetic spectrum.

Some devices integrate two different image sources and enable a user to switch from one to another. For example during the day it would make sense to image in the visible spectrum whereas at night it would make sense to switch to “night vision” or thermal imaging approaches. Switching colour palettes can also be used to enhance images obtained in non-visible regions of the spectrum, for example to highlight hot spots or even to reduce eye fatigue.

It is known to apply image enhancing techniques in order to sharpen images and increase detail, but such approaches may introduce artefacts and in any case rely on the original image data being good enough for such enhancement techniques to bring out the desired detail.

It is also known to enhance images obtained with such devices by combining image data from multiple sources. For example, the concept of “Fusion” as it relates to such devices describes a type of product which augments or combines (“fuses”) images from two different image sources. However the resulting image tends to be of poor quality and while infrared data might enhance a visible image in some ways it has a tendency to obscure detail that would otherwise be helpful. It is also challenging to compensate for image displacement, magnification differences, viewing angles, and differences in image quality and levels.

Fusion type devices also tend to be very expensive and they rely on complex image processing techniques to obtain usable images. This puts such technology outside of the reach of hobbyists and the like.

It is an object of at least one aspect of the present invention to provide an observation device which provides increased functionality and improved utility over conventional observation devices.

The Applicant has also realised that there can be problems with specific implementations and/or use cases and it is therefore an object of at least one embodiment of the present invention to solve such problems and provide enhanced functionality and utility over conventional observation devices.

Further aims and objects of the invention will become apparent from reading the following description.

### SUMMARY OF THE INVENTION

According to a first aspect of the invention there is provided an observation device, the observation device comprising:
a first imaging module; and
a second imaging module;
wherein the first and second imaging modules are configured to obtain images of substantially the same scene but are sensitive to different regions of the electromagnetic spectrum; and
wherein the observation device is configured to generate a composite image in which a portion of an image obtained by the second imaging module is superimposed on an image obtained by the first imaging module, or a portion of an image obtained by the first imaging module is superimposed on an image obtained by the second imaging module.

For the avoidance of doubt, the portion of the image obtained by the second (or first) imaging module which is superimposed on the image obtained by the first (or second) imaging module occupies only a portion (not the whole) of the composite image, such that the majority of the composite image is comprised of the first (or second) image and the portion of the second (or first) image occupies less than (and preferably much less than) 50% of the composite image.

The term “substantially the same scene” is used to acknowledge that when the imaging modules are pointed in the same direction but necessarily separated there will be some difference in the coverage obtained resulting from a slightly different viewing axis, sensor size, etc. What is important is that a subject of interest can be imaged using both imaging modules. Another way of defining this might be to say that the field of view of the first and second imaging modules at least partially overlap.

Most preferably, the composite image is updated in real time. That is, the images obtained by the first and second imaging modules are updated in real time. Put another way, the images are live.

Optionally, the first and second imaging modules are removably attached to one another and/or the observation device. Alternatively, and preferably, the first and second imaging modules are integrated within a single housing.

The first and second imaging modules may be selected from the group comprising a thermal camera or thermal scope, an infrared camera or infrared scope, and a visible camera or visible scope. The first and/or second imaging modules may comprise a CMOS sensor, CCD camera, thermographic camera, or the like.

Preferably, the observation device is configured to toggle between a first mode of operation in which a portion of an image obtained by the second imaging module is superimposed on a corresponding image obtained by the first imaging module, and a second mode of operation in which a portion of an image obtained by the first imaging module is superimposed on a corresponding image obtained by the second imaging module.

Preferably, the observation device further comprises a display module configured to display the composite image. The display module may be removably attached to the observation device. Alternatively, the display module may be integrated with the first and second imaging modules within a single housing.

The display module may be monocular or binocular.

Optionally, the observation device has a third mode of operation in which the display module displays the image obtained by one of the first or second imaging modules (but not the other). Optionally, the observation device has a fourth mode of operation in which the display module displays the image obtained by the other of the first or second imaging modules (but not that of the third mode of operation).

Alternatively, or additionally, the observation device is configured to generate a video feed of the composite image, and (where appropriate) of the images obtained by the first and second imaging modules. The source of the video feed may be selected by a user.

Preferably, the observation device is configured to overlay a reticle on each of the image and the portion of the image obtained by the first and second (or vice versa) imaging modules. The reticle may take any suitable or desirable form but preferably comprises cross hairs.

Preferably, the observation device is configured to compensate for parallax such that each reticle is located in the same position in the first (or second) image and the portion of the second (or first) image relative to a subject being observed.

Optionally, the observation device is configured to determine an offset between the lines of sight (or viewing axes) of the first and second imaging modules at a distance corresponding to the subject, and determine a corresponding offset in the first and second images.

Alternatively, the observation device is configured to overlay a reticle on one of the image or the portion of the image but not the other.

Optionally, the portion of the second (or first) image corresponds to a selected portion of the first (or second) image. Preferably, the observation device is configured to allow a user to select the portion of the first (or second) image. Optionally, the selection is visibly marked or identified on the composite image, for example using a rectangular lasso or other suitable indicia.

Optionally, the portion of the second (or first image) is displayed at the same magnification as the first (or second image). Alternatively, the portion of the second (or first) image is displayed at a higher magnification than the first (or second) image. Optionally, the magnification of the first and the second image may be controlled in use.

Optionally, the observation device is configured to allow a user to select the location of the portion of the second (or first) image in the composite image. Alternatively, the location of the portion of the second (or first) image in the composite image is fixed.

Optionally, a portion of the image obtained by the first imaging module is also superimposed on the image obtained by the first imaging module. Preferably, the portion of the image is magnified. Optionally, a plurality of portions of the images obtained by the first and/or second imaging modules are superimposed on the image obtained by the first or the second imaging module.

According to a second aspect of the present invention, there is provided a scope or sighting device comprising an observation device according to the first aspect.

The observation device may be comprised in the scope or sighting device. Alternatively, the observation device may be removeably attached to the scope or sighting device. The observation device may be configured as a rifle scope front attachment.

The scope may comprise a display module of the observation device. One or both of the imaging modules may be removably attached to the scope, or from the rifle scope front attachment. Optionally, the imaging modules may be replaced with like or alternative imaging modules.

Preferably, one or other of the imaging modules are calibrated to a zero point associated with a rifle to which the scope is attached.

Embodiments of the second aspect of the invention may comprise features to implement the preferred or optional features of the first aspect of the invention or vice versa.

### BRIEF DESCRIPTION OF DRAWINGS

There will now be described, by way of example only, various embodiments of the invention with reference to the drawings (like reference numerals being used to denote like features, whether expressly mentioned in the detailed description below or not), of which:

FIG. 1 is a schematic view of an observation device according to the present invention;

FIG. 2 is a schematic view of a rifle scope comprising the observation device shown in FIG. 1 in a first configuration;

FIG. 3 is a schematic view of a rifle scope comprising the observation device shown in FIG. 1 in a second configuration; and

FIG. 4 shows two representative images of a display image produced by an observation device according to the present invention.

Unless stated otherwise, features in the drawings are not to scale. Scales are exaggerated in order to better illustrate the features of the invention and the problems which the invention are intended to address.

### DETAILED DESCRIPTION OF THE PREFERRED EMBODIMENTS

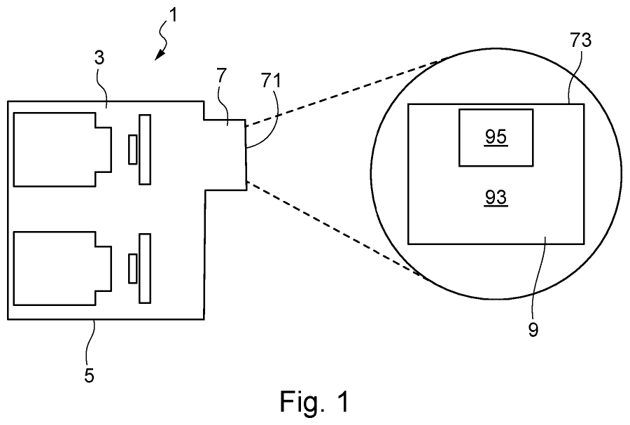

FIG. 1 is a schematic view of an observation device 1 which can be seen to comprise a first imaging module 3, a second imaging module 5, and a display module 7. The observation device also comprises a housing 11, which integrates or houses the first imaging module 3, second imaging module 5, and display module 7 in a single, self-contained or standalone device.

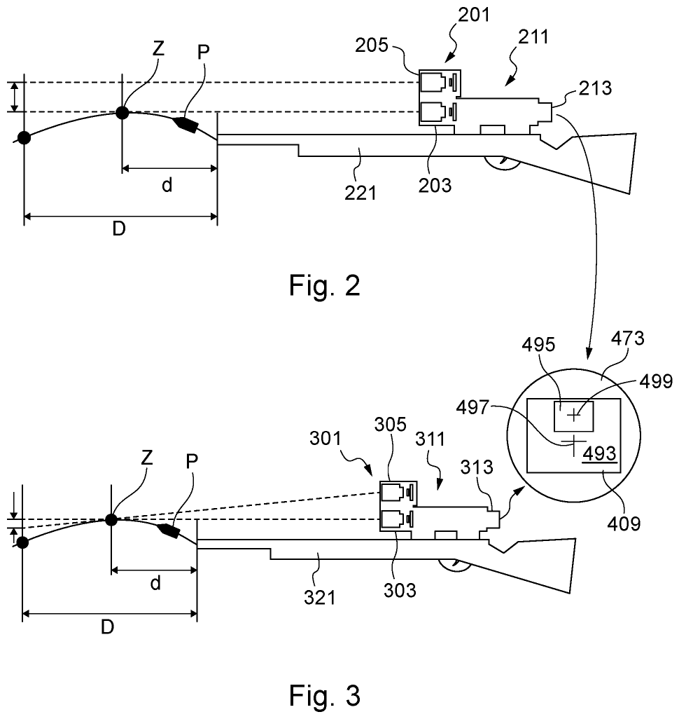

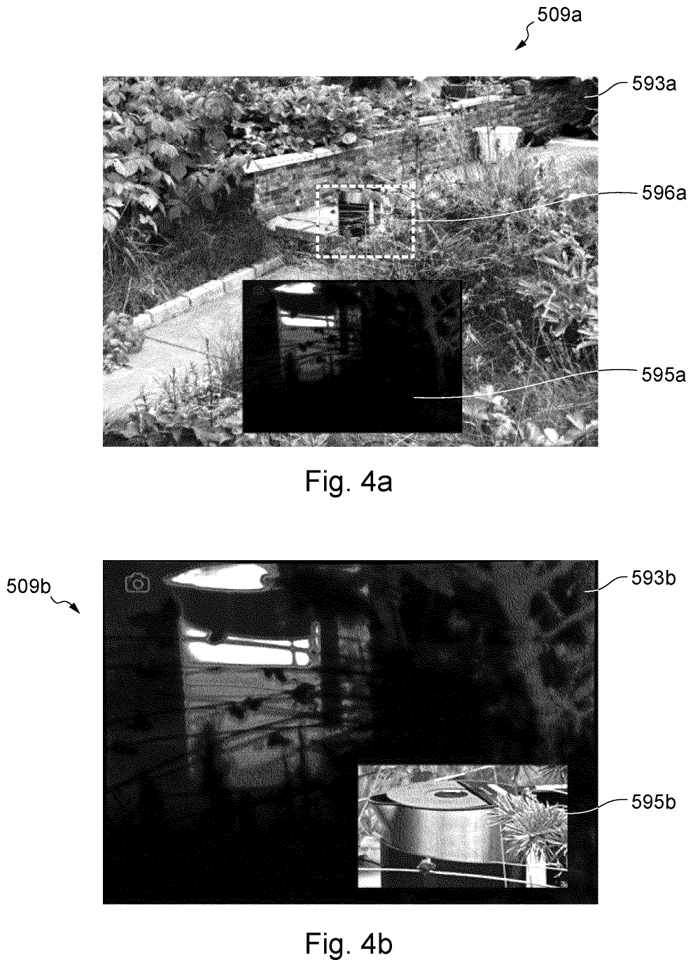

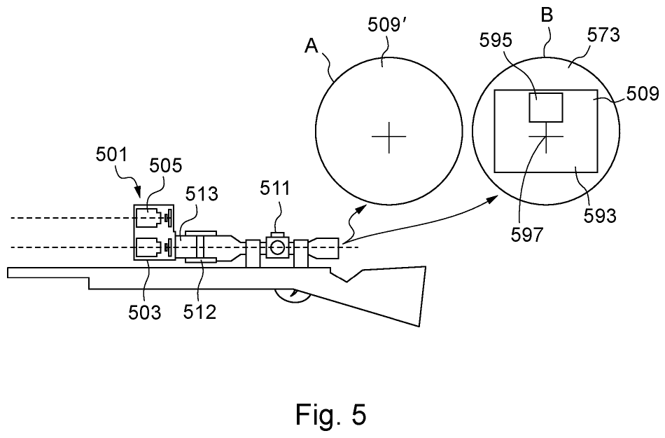

Shown in the inset is the image 9 as viewed through an eyepiece or viewing aperture 71 of an electronic view finder (EVF) 73 within the display module 7. The image 9 may be that observed by a user in the event the observation device is a standalone device, or that which is subsequently imaged by or viewed through a scope (e.g. see discussion of FIGS. 2 and 3 below) when the observation device is an attachment or “bolt-on” to a separate device. FIG. 4, discussed further below, is a real-life example of images viewed through an observation device according to an embodiment of the invention.

The image 9, which may be termed a composite image, comprises a main image 93 and an auxiliary image 95. The auxiliary image 95 occupies a smaller region of the composite image 9 than the main image 93, and the auxiliary image 95 is (effectively) superimposed on the main image 93.

In this example, the main image 93 is obtained from the first imaging module 3, and the auxiliary image 95 is obtained from the second imaging module 5. Importantly, the first imaging module 3 is of a different type to the second imaging module 5. Put another way, the first imaging module 3 obtains an image in a first region of the electromagnetic spectrum and the second imaging module 5 obtains an image in a second, different, region of the electromagnetic spectrum.

(It is contemplated that there may be some overlap between the respective detection ranges of the first and second imaging modules in any particular embodiment, but what is important is that they detect a substantially different range overall so that a user is able to benefit from two different images or two different image types of the same scene, i.e. that the overlap in any information content is insignificant. For example, a visible light sensor may detect some near-infrared radiation, but would capture no light in the mid-infrared region, and vice versa).

In this embodiment, the main image 93 is a visible image, meaning that the first imaging module 3 is configured to obtain an image in the visible region of the electromagnetic spectrum (generally acknowledged to be approximately 400 to 700 nm) using a sensor such as a CMOS or CCD sensor. The auxiliary image 95 is a thermal image, obtained using a thermographic camera 5 which is sensitive to the infrared region of the electromagnetic spectrum (generally 1 to 14 μm). It will of course be understood that any kind of imaging device and any desirable sensing region might be employed; again, what is key is that they are different.

Note that in use, a user may toggle the sources of the main 93 and auxiliary 95 images; that is, perhaps by a simple button press, scroll wheel, or capacitive sensor, a user can alternate between the source arrangement above and shown in FIG. 1 and an alternate arrangement in which the main image 93 is obtained from the second imaging module 5, and the auxiliary image 95 is obtained from the first imaging module 3. It is envisaged that any selection, reticule or cross-hair position (see below), zoom level, etc. is preserved during the toggle such that the user simply experiences an apparent source shift. In other words, the user has the impression that the source of the main 93 and auxiliary 95 images simply changes “mode” from one image type to another.

In case it is helpful to the user, it is also envisaged that the observation device 1 might also present the main image 93 or the auxiliary image 95 alone, as further display options.

Although the observation device 1 is described above as being a single, standalone device, in an alternative embodiment (not shown) a first imaging module, a second imaging module, and a display module may be separate, modular components that are attached in use but can be disassembled and reattached in a different configuration depending on the particular use case or application. Furthermore, this would allow one or both of the imaging modules to be replaced with alternative imaging modules, and the display module likewise. This might be for repair purposes, to allow a user to upgrade their device, or might be to provide different functionality by imaging a different part of the electromagnetic spectrum, to provide a larger display, or to accommodate integration in other systems.

Note that the display module may be monocular or binocular. If the display module is monocular it is foreseen that it could be made binocular by adding another like display module.

The observation device 1 is also described as being standalone in the context of being a device which a user can use independent of any other equipment to observe a scene and overlay a corresponding image, but as intimated above the observation device 1 may be fitted to or integrated with a rifle or other type of scope, or alternatively configured as a rifle or other type of scope, such as illustrated in FIG. 2 and FIG. 3.

For example, in a modular embodiment the display module might be removed to attach the observation device to a scope, for example a digital scope, which takes the place (or serves the purpose) of the display module. In another example, the observation device may not be provided with a display module at all, and configured for the express purpose of attaching to a scope, for example a digital scope. It is also possible that the image provided by a display module might be viewed through a scope.

In FIG. 5, discussed in more detail below, an observation device 501 is in the form of a so-called “front attachment” and is shown attached to a rifle sight 511 whereas in FIGS. 2 and 3 a rifle sight 211, 311 incorporates imaging modules 203,205, 303,305 in a unitary body, or put another way the observation device 201,301 is itself configured as a rifle scope. In the FIG. 2 and FIG. 3 embodiments the display module might include the scope objective 213,313 or the scope objective 213,313 might effectively be the display module, whereas in the FIG. 5 embodiment the observation device 501 is configured to enable a user to view the display module through the scope objective 513. It is foreseen, for example, that an observation device might output a video feed comprising the composite image (or whatever image is currently being generated by the observation device, that is the source may be user selected). This video feed may be input into any suitable display and/or recording device or system or transmitted, for example, to a smartphone app or the like. For the purposes of the present description, and by way of example only, the video feed may be input to a digital rifle scope.

When embodied in a rifle scope the scope 211,311 is preferably configured for attachment to a rifle 221,321 using standard means such as retaining rings or scope rings. The manner of attachment is unimportant and to a large degree irrelevant; what is important is the technical features which may be common to all embodiments regardless of application. Primarily, this is the ability of a user to toggle between “modes” as discussed above, but there are also secondary, advantageous but non-essential features of preferred embodiments which are now described in the rifle scope context but which apply to other embodiments such as spotting scopes, rangefinders, and the like.

Shown in the inset of FIG. 3 is an image 409 as viewed through scope objective 213 or 313. As above, the image 409, which again may be termed a composite image, comprises a main image 493 and an auxiliary image 495. The auxiliary image 495 occupies a region of the composite image 409 roughly 20% of area of the main image 493 and is positioned above centre of the main image 493 on which it is (effectively) superimposed.

In this example, the main image 493 is obtained from the first imaging module 203 or 303, and the auxiliary image 495 is obtained from the second imaging module 205 or 305. As explained above, it is important that the first imaging module 203 or 303 is of a different type to the second imaging module 205 or 305, respectively. In this embodiment, the main image 493 is an infrared image (the first imaging module 203 or 303 being an infrared camera) and the auxiliary image 495 is a visible image, obtained using a CMOS sensor.

As before, a user may toggle the sources of the main 493 and auxiliary 495 images; between the source arrangement above, an alternate arrangement in which the main image 493 is obtained from the second imaging module 205 or 305 and the auxiliary image 495 is obtained from the first imaging module 203 or 303, and optionally to view the main image 493 or the auxiliary image 495 alone.

What is important in these embodiments of the observation device 201, 301 is the provision in the composite image 409 of synchronised cross hairs 497,499 which, for example, ensure that the cross hair 499 on the auxiliary image 495 is in the same position relative to a subject being observed as the cross hair 497 on the main image 493. This is not trivial because the distance to a subject is not fixed and there is an inherent difference in the field of view of the first 203,303 and second 205,305 imaging modules-a form of parallax.

FIG. 2 shows an embodiment in which the first 203 and second 205 imaging modules of the observation device 201 are parallel. In this arrangement the lines of sight (or viewing axes) of the imaging modules 203,205 are likewise parallel. If the distance to a subject from, say, the first imaging module 203 can be determined by the observation device (for example by means of a rangefinder) or provided to the observation device manually by the user, and assuming the height difference between the lines of sight (or viewing axes) is constant, the location of the cross hair 497 on the main image 493 can be mapped onto a corresponding location on the auxiliary image 495 where the cross hair 499 should be located so as to identify the same point in space. In the Figure, which exaggerates some features such as the trajectory of projectile p, d is the distance to the so-called “zero point” Z which is the point at which the line of sight (or viewing axis) intersects the trajectory of projectile p. Typically this distance might be 50 yards or 100 metres. Knowing this distance, the separation of the lines of sight (or viewing axes) gives an offset at the subject distance from which an offset between the first and second images can be determined.

FIG. 3 shows an embodiment in which the first 303 and second 305 imaging modules of the observation device 301 have converging lines of sight (or viewing axes). In this case the lines of sight (or viewing axes) are made to converge at the “zero point” Z. At this distance therefore, a reticle located in the same location (say, the centre) in both images would coincide. However, as the subject distance increases or decreases, this alignment will steadily drift but in a generally linear manner. Accordingly, by determining the distance to the subject it will be possible to determine the corresponding separation between lines of sight (or viewing axes) at that distance, and determine a corresponding offset between the first and second images.

Again, the distance to the subject from, say, the first imaging module 303 can be determined by the observation device (for example by means of a rangefinder) or provided to the observation device manually by the user. The location of the cross hair 497 on the main image 493 can likewise be mapped onto a corresponding location on the auxiliary image 495 where the cross hair 499 should be located so as to identify the same point in space.

Note that in both cases the field of view of the imaging modules will still overlap significantly to the extent that one can always expect the observation device to be able to generate the desired composite image. It is however envisaged that control of the orientation of one or other of the imaging devices in the FIG. 3 embodiment might enable the degree of overlap to be assured at any possible distance to a subject. It should also be noted that while for convenience the preceding embodiments are described in the context of rifle scopes, the same ability to overlay synchronised reticles applies to standalone observation devices or “front attachment” devices such as described below.

It is foreseen that in some embodiments it might be desirable to provide only a single cross-hair or reticle, in which case the synchronisation/calibration of multiple cross-hairs or reticles may not be required.

In the embodiments above the two imaging modules are parallel or are at least pointed in generally the same direction. The problem of parallax might be overcome in a specific embodiment if the line of sight of both imaging modules can be made effectively colinear by mounting one imaging module perpendicular to the other (and the desired line of sight) and using a beamsplitter or similar to direct or divert incoming light to the perpendicular imaging module.

FIG. 4 shows two examples of a composite image as may be generated by an observation device according to the present invention. In FIG. 4 (a), the main image 593a can be seen to comprise a visible image of a garden scene in which a kettle is partially obscured by some plants. The auxiliary image 595a is an image showing an enlarged portion of an infrared image corresponding to the user-selected region 596a. In this case the selection is made using a lasso overlaid on the composite image 509a. The utility of such an arrangement is clear; in infrared the kettle (which is revealed to be warm) is visually striking in infrared whereas the rest of the scene might be relatively featureless. In contrast, in the visible spectrum while the kettle is hard to make out, features such as walls, steps, paths, borders and vegetation are easily made out. While the auxiliary image is enlarged, it may be shown at the same level of magnification and indeed the user May choose to zoom in or out of the auxiliary image in use.

While it is helpful to be able to define the portion of the second image which forms the auxiliary image by selecting an area on the main image, in practice this might be fixed so that, for example, it consistently shows an enlarged version of the centre of the main image, in a different image type. This may be particularly relevant when overlaying a reticle which it might be preferred to locate centrally.

In FIG. 4 (b) the mode has been switched such that the main image 593b is now provided by the infrared source and the auxiliary image 595b is provided by the visible source. In this image, both views are enlarged, significantly, but to different degrees of magnification. As noted above, these magnifications can be controlled independently so as to obtain an image which has some utility to the user. The location of the auxiliary image 595b can also be changed by a user, for example using cursor keys or a simple menu or the like.

Note that while in the above examples a single auxiliary image is superimposed on the main image, it is foreseen that multiple (or a plurality of) auxiliary images may be superimposed on the main image. The auxiliary images may be portions of either or both of the images obtained from the imaging modules. For example, the composite image shown in FIG. 4 might be enhanced by providing a further auxiliary image such as a visible image of the entire garden scene (which is clearly at a different magnification than those shown, It might be further enhanced by providing a yet further auxiliary image such as an infrared or thermal image of the entire garden scene. Each auxiliary image can be controlled in terms of position in the composite image, and/or magnification, and/or image source.

As discussed briefly above, FIG. 5 shows an embodiment of an observation device 501 in the form of a so-called “front attachment” which is attached to a rifle scope 511. A conventional rifle scope front attachment allows an optical rifle scope to be converted into a night vision or thermal rifle scope; in this embodiment the front attachment observation device 501 converts a conventional optical rifle scope into a rifle scope which may then provide one or more of the various advantages of the rifle scope devices 211, 311 described above. In the embodiment shown in FIG. 5, the front attachment observation device 501 is attached to the objective part of the rifle scope 511, but it might alternatively be mounted on the rifle in front of the scope 511. A ring adapter 512 (optional) may be used to control the spacing between the objective part of the rifle scope 511 and the display module 513. The display module 513 can be provided with an optical arrangement by which the rifle scope 511 is able to focus on the display 573 such that a user can view the composite image 509 through the rifle scope 511.

Shown in inset A of FIG. 5 is an image 509′ as would be visible through the rifle scope 511 without the front attachment observation device present, and in inset B of FIG. 5 is an image 509 on display 573 as viewed through the rifle scope 511 with the front attachment observation device 501 attached. As above, the image 509, which again may be termed a composite image, comprises a main image 593 and a superimposed or overlaid auxiliary image 595. The auxiliary image 595 occupies a smaller region of the display 573 than the main image 593 which can be seen to occupy the majority of the display 573.

The main image 593 may be obtained from either the first imaging module 503 or the second imaging module 505, the auxiliary image 595 obtained from the other imaging module 505 or 503, respectively. Any of the embodiments herein described may comprise further imaging modules (i.e. the invention is not limited to two but extends to any plurality) but as explained above it is important that at least two of the imaging modules are of a different type. Likewise, a user may toggle the sources of the main 593 and auxiliary 595 images, which may be derived from any of the imaging modules 503,505 (or any additional modules) in any desired combination. Synchronised cross hairs can also be provided in the manner described above, or a single cross hair 597 might be provided (in either image or sub-image). In fact, the single cross hair in this embodiment might be provided by the optical rifle scope 511 rather than the front attachment observation device 501.

The invention provides an observation device, which for example can be comprised in a scope or sighting device, which has first and second imaging modules (e.g. cameras, imagers, or the like) that obtain images of substantially the same scene or within overlapping fields of view but in different regions of the electromagnetic spectrum (e.g. infrared, thermal, visible, etc.) in a self-contained device or a modular device (where the modules are attached in use). The observation device generates a composite image in which a portion of an image obtained by one imaging module (i.e. in one region of the electromagnetic spectrum) is superimposed on another image (of substantially the same scene or within an overlapping field of view) obtained by the other imaging module (i.e. in a different region of the electromagnetic spectrum). The portion of the image which is superimposed on the other image occupies only a portion (i.e. not the whole, and preferably much less than 50%) of the composite image.

The foregoing description of the invention has been presented for purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention as defined by the appended claims.

1. An observation device comprising:
a first imaging module; and
a second imaging module:
wherein the first and second imaging modules are configured to obtain images of substantially the same scene but are sensitive to different regions of the electromagnetic spectrum, wherein the first imaging module is configured to obtain a first image of said images, and wherein the second imaging module is configured to obtain a second image of said images: and
wherein the observation device is configured to generate a composite image in which:
(a) a portion of the second image image obtained by the second imaging module is overlaid on the first image obtained by the first imaging module, wherein the portion of the second image occupies less than 50% of the composite image, or
(b) a portion of the first image obtained by the first imaging module is overlaid on the second image obtained by the second imaging module, wherein the portion of the first image occupies less than 50% of the composite image.

2. (canceled)

3. The observation device of claim 1, wherein the composite image is updated in real time.

4. The observation device of claim 1, wherein the first and second imaging modules are:
removably attached to one another;
removably attached to the observation device;
removably attached to one another and the observation device; or integrated within a single housing.

5. (canceled)

6. (canceled)

7. The observation device of claim 1, wherein the first and second imaging modules are selected from the group comprising a thermal camera or thermal scope, an infrared camera or infrared scope, and a visible camera or visible scope, CMOS sensor, CCD camera, or a thermographic camera.

8. The observation device of claim 1, wherein the observation device is configured to toggle between a first mode of operation in which a portion of an image obtained by the second imaging module is overlaid on a corresponding image obtained by the first imaging module, and a second mode of operation in which a portion of an image obtained by the first imaging module is overlaid on a corresponding image obtained by the second imaging module.

9. The observation device of claim 1, wherein the observation device further comprises a display module configured to display the composite image wherein the display module is removably attached to the observation device or integrated with the first and second imaging modules within a single housing.

10. (canceled)

11. (canceled)

12. The observation device of claim 8, wherein the observation device has a third mode of operation in which the display module displays the image obtained by one of the first or second imaging modules but not the image obtained by the other of the first or second imaging modules.

13. The observation device of claim 12, wherein the observation device has a fourth mode of operation in which the display module displays the image obtained by the other of the first or second imaging modules but not the image displayed by the display module during the third mode of operation.

14. The observation device of claim 1, wherein the observation device is configured to generate a video feed of the composite image.

15. The observation device of claim 1, wherein the observation device is configured to overlay a reticle on at least one of the image and the portion of the image obtained by the first and second imaging modules.

16. The observation device of claim 15, wherein the observation device is configured to compensate for parallax such that each reticle is located in the same position in:
the first image and the portion of the second image relative to a subject being observed; or the second image and the portion of the first image relative to the subject.

17. The observation device of claim 16, wherein the observation device is configured to determine an offset between lines of sight or viewing axes of the first and second imaging modules at a distance corresponding to the subject, and determine a corresponding offset in the first and second images.

18. (canceled)

19. The observation device of claim 1, wherein:
the portion of the second image corresponds to a selected portion of the first image, wherein the observation device is configured to allow a user to select the portion of the first image; or the portion of the first image corresponds to a selected portion of the second image. wherein the observation device is configured to allow a user to select the portion of the second image.

20. (canceled)

21. The observation device of claim 19, wherein the selection is visibly marked or identified on the composite image, using a rectangular lasso or other suitable indicia.

22. The observation device of claim 1, wherein:
the portion of the second image is displayed at the same magnification as the first image;
the portion of the first image is displayed at the same magnification as the second image:
the portion of the second image is displayed at higher magnification than the first image:
the portion of the first image is displayed at higher magnification than the second image: or
wherein the magnification of the first and second image may be controlled in use.

23. (canceled)

24. (canceled)

25. The observation device of claim 1, wherein the observation device is configured to allow a user to select a location of:
the portion of the second image in the composite image; or the portion of the first image in the composite image.

26. (canceled)

27. The observation device of claim 1, wherein a plurality of portions of the images obtained by at least one of the first or the second imaging modules are overlaid on the image obtained by the first or the second imaging module.

28. A scope or sighting device comprising an observation device according to claim 1.

29. The scope or sighting device of claim 28, wherein the observation device is:
comprised in the scope or sighting device;
removeably attached to the scope or sichting device; or
configured as a rifle scope front attachment.

30. (canceled)

31. (canceled)

32. The scope or sighting device of claim 28, wherein one of the first and second imaging modules is calibrated to a zero point associated with a rifle to which the scope is attached.
